(19) United States
(12) Patent Application Publication
(10) Pub. No.: US 2009/0221084 A1
(43) Pub. Date: Sep. 3, 2009

(54) METHOD AND APPARATUS FOR DETECTING STIMULANTS IN A LIQUID MEDIUM

(76) Inventors: Marsha Walker, Boulder, CO (US); Taro P. Smith, Boulder, CO (US)

Correspondence Address: POLSINELLI SHUGHART PC, 700 West 47th Street, Suite 1000, KANSAS CITY, MO, 64112, US

(21) Appl. No.: 12/397,218

(22) Filed: Mar. 3, 2009

Related U.S. Application Data
(60) Provisional application No. 61/033,273, filed on Mar. 3, 2008.
(60) Provisional application No. 61/079,760, filed on Jul. 10, 2008.

(51) Int. Cl. G01N 27/00

(52) U.S. Cl. 436/150; 422/82.02

(57) ABSTRACT

A sensor and testing methodology for detecting and measuring the level of stimulants in a liquid is disclosed. The sensor is compact in form, approximately the size and shape of a fountain pen, and may be conveniently transported in a user's pocket or purse. The device includes a battery, a test strip having an electrical conductor coupled to an electrode and an indicator for providing a visual indication of the presence and level of a stimulant in a liquid. In use, the test strip is exposed to the liquid being tested, and the flow of electrons between the conductor and the electrode is measured and calibrated to indicate the type and concentration level of stimulant present.

### CROSS-REFERENCE TO RELATED APPLICATIONS

This application claims the benefit of U.S. Provisional Application No. 61/033,273 filed Mar. 3, 2008 and U.S. Provisional Application No. 61/079,760 filed Jul. 10, 2008, both which are incorporated herein by reference in their entirety as if fully set forth herein.

### FIELD OF THE INVENTION

The present invention relates generally to the detection of stimulants in a liquid medium, and, more particularly, to a cost-effective, portable sensor and method that enables a user to easily determine the presence and concentration of a stimulant in a beverage prior to its consumption.

### BACKGROUND OF THE INVENTION

Certain stimulants which belong to a class of compounds called methylxanthines or xanthine alkaloids, are probably the most widely consumed legally available drugs in the world. This class of stimulatory compounds includes caffeine, also known as mateine (matteine) and guaranine, which is present in beverages such as coffee, tea, hot chocolate and certain soft drinks. Caffeine may be further broken down to theobromine, theophylline and paraxanthine, all of which may be active compounds found in widely available beverages. For many people, caffeine is a useful stimulant and is consumed to provide an energy boost or a feeling of heightened alertness, particularly in situations where an individual is required by his or her work schedule or study program to stay awake longer than normal.

From a medical perspective, these compounds stimulate the brain in the same manner as amphetamines, cocaine and heroin, albeit in a much milder manner. However, the same addictive properties that are found in the more potent and consequently, more dangerous stimulants referenced above, are present in caffeine and other stimulants and are related to the chemical mechanisms involved in sustaining alertness. Specifically, drowsiness is caused by binding adenosine, a chemical created within the brain, to certain adenosine receptors which slow down nerve cell activity and dilate blood vessels in the brain. Caffeine simulates the nerve cell binding properties of adenosine and, therefore, binds to the adenosine receptors in the same manner as pure adenosine. However, caffeine does not result in a reduction of nerve cell activity, and, as a result, nerve cell activity remains the same or may even increase, since no receptors are available to bind with adenosine.

Moreover, it is known that amphetamines increase the dopamine levels in the brain. Dopamine is a neurotransmitter that activates the pleasure center in certain parts of the brain. Caffeine increases dopamine levels in the brain in the same manner as amphetamines, and this property of caffeine may explain in part its addictive properties. Other effects of caffeine include increased pituitary gland activity which results in the release of certain hormones such as adrenaline or epinephrine, which result in papillary dilation, bronchodilation, tachycardia, superficial vascular constriction, an increase in blood pressure, unpleasant gastrointestinal effects, insomnia and other potentially undesirable physical reactions.

In view of the foregoing, people have become increasingly concerned about the effects that stimulants may have upon the human body, some of which may be long-term. By way of example, certain individuals may have an allergic reaction to caffeine, and pregnant or nursing women may avoid caffeine due to potential harmful effects upon the fetus or nursing infant. Additionally, elderly populations are particularly susceptible to caffeine with disruption in calcium metabolism affecting bone density and increase sensitivity to blood pressure effects of caffeine.

Known methods and devices exist for detecting the presence and measuring the concentration of caffeine in a beverage. However, most are suitable only for use in a laboratory or are not portable so as to be capable of use in a restaurant or coffee shop where a user could verify that the decaffeinated beverage just ordered is, indeed, free of caffeine. For example, the caffeine detector disclosed in U.S. Patent Application Publication No. 2004/0115092 by Starr discloses an antibody-based detection strip which may be dipped into a beverage for purposes of determining its caffeine content. However, the caffeine concentration is not available immediately. Rather, following dipping into the beverage, the detection strip must be dipped sequentially in a wash solution and then in one or two reagents before an indication is readable.

U.S. Pat. No. 6,557,484 B1 issued to Engelman, May 6, 2003, discloses a straw which may contain either a sugar or a caffeine detection element or both contained within the body of the straw. However, this device is relatively complex in its design and difficult to manufacture.

The stimulant detection device or sensor and the method for using it in accordance with the present invention overcome these and other problems by providing a portable, cost-effective, reliable and easy to use detection device and methodology which may be used in eating establishments, cafés and coffee shops by customers to verify the presence or absence of caffeine or other stimulants in beverages, in particular those beverages which are purportedly “decaffeinated.” The sensor may also be used to determine the concentration of caffeine in a beverage where its presence has been detected.

### BRIEF DESCRIPTION OF THE DRAWINGS

FIG. 1 is a perspective view of a sensor according to an embodiment of the present invention;

FIG. 2 is an enlarged sectional view of the sensor electrode construction according to an embodiment of the present invention;

FIG. 3 is a graph of measured peak current in the sensor plotted as a function of caffeine concentration;

FIG. 4 is a graph of a series of voltammograms obtained for different caffeine concentrations measured by the sensor of the present invention;

FIG. 5 is graph of average peak currents measured at high and low caffeine concentrations over a series of tests;

FIG. 6 is a plot of voltammograms obtained for various coffee samples of unknown caffeine concentration in accordance with the present invention; and

FIG. 7 is a graphical depiction of peak current responses for positive and negative voltages applied to various liquids in accordance with the present invention.

### DESCRIPTION OF THE INVENTION

Before proceeding with the detailed description, it should be noted that the present teaching is by way of example, not by limitation. The concepts presented herein are not limited to use or application with one specific type of stimulant sensor or detection apparatus and methodology. Thus, although the instrumentalities described herein are for the convenience of illustration and explanation, shown and described with respect to exemplary embodiments, the principles disclosed herein may be applied to other types of stimulant detectors and detection methods.

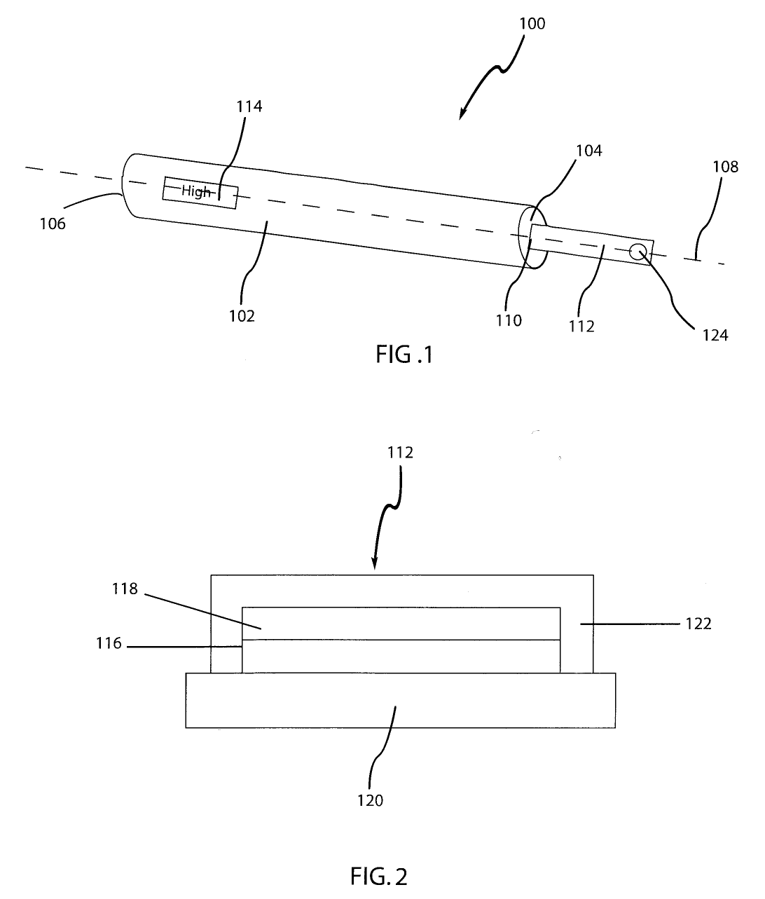

Referring now to FIG. 1, a stimulant sensor or detector 100 is illustrated in perspective. The detector 100 is approximately the size of a fountain pen and is designed with a view of being easily portable, for example, in a user's shirt or pants pocket or in a purse. The detector includes a generally elongate body portion 102 having a first end 104, a second end 106 and a longitudinal axis 108 extending the length of the elongate body portion. A slot or aperture 110 is formed in the first end which extends into the detector body along the longitudinal axis 108 and is adapted to removably receive a test strip 112. A power source (not shown), by way of example, a AA or AAA battery, may be mounted within or exterior to the detector body by suitable mounting means, as is known in the art. An indicator 114 formed in the body portion 102 provides a visual indication of the stimulant level in the material being tested and, in an embodiment, would provide either an actual concentration value, a range of concentrations or a high-low reading.

Referring to FIG. 2, the test strip 112 is shown in cross section in greater detail. In the embodiment shown, the test strip includes at least one electrode layer 116 which is selected to be responsive to the presence of a stimulant, by way of example, caffeine, and is positioned or deposited on an inert supporting surface or substrate 120. However, it is to be understood that multiple electrodes or electrode layers may be employed on a single test strip without departing from the scope of the present invention. The substrate may be glass, a plastic or some other suitable supporting material, and the at least one electrode may be positioned or deposited thereon by means of screen, ink-jet, or other suitable contact or non-contact printing or deposition processes. In an embodiment, a protective coating layer 122 may be applied to cover the test strip to minimize contamination and potentially erroneous or false readings resulting therefrom.

### Example

The stimulant sensor proof-of-concept was demonstrated using carbon paste electrodes modified with a sensitizer for caffeine. Modified carbon paste electrodes were prepared by mixing 90 percent by weight graphite powder with 10 percent by weight mineral oil. However, a mixture in the range of between approximately 70 to approximately 99 percent by weight of graphite powder and approximately one to approximately 30 percent by weight mineral oil may be used with an addition of between approximately 5 percent by weight to approximately 15 percent by weight of sensitizer, depending upon the application. For the initial testing, 9 percent by weight p-benzoquinone was added as a sensitizer, which was selected based upon caffeine as the test stimulant, it being understood that other sensitizers may be employed for various stimulants other than caffeine without departing from the scope hereof.

The mixture was homogenized by grinding in a mortar for 20 minutes. The material was allowed to sit for at least 24 hours before further electrode fabrication. The modified electrode material was then packed into a glass capillary tube (1.5-1.8 mm inner diameter). An electrical conductor in the form of a copper wire was inserted from the other end of the capillary for electrical contact; although, other conductor materials and configurations may be used, as well. The electrode surface was smoothed and regenerated by polishing with weighing paper. Before use, all electrodes were cleaned with phosphate buffer at pH 5.8 containing 200 mM KH₂PO₄ and 200 mM NaOH using cyclic voltammetry (CV) cleaning from −1.0 V to 1.0 V for 20 cycles.

Differential pulse voltrammetry measurements (DPVs) of each sample were taken over the voltage range of −0.4 to 0.6 V. Phosphate buffered saline (PBS) blanks were run first and between each concentration of caffeine observed. Concentrations of caffeine were observed starting with the lowest concentration and then looking at the next higher concentration. Only one measurement was taken for each caffeine concentration. Peak currents were obtained manually using the instrument software. For each condition, three peak currents were obtained and averaged to determine the maximum peak current. Blind samples consisting of decaffeinated and caffeinated coffee samples were also prepared and tested according to the optimized protocol.

### Results

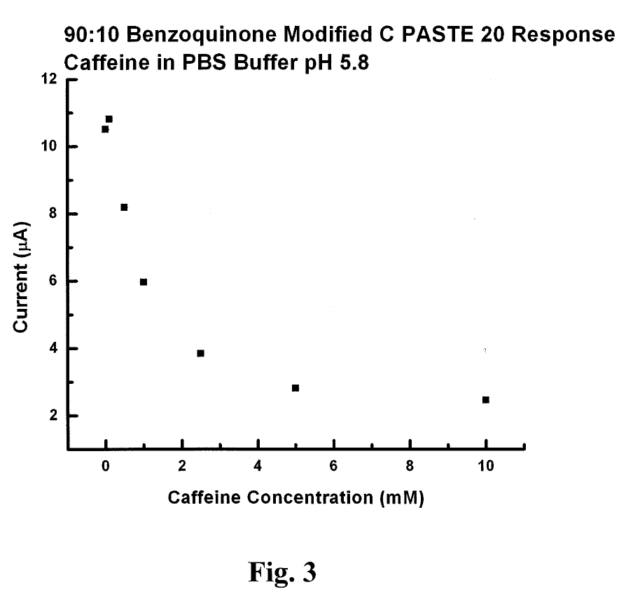

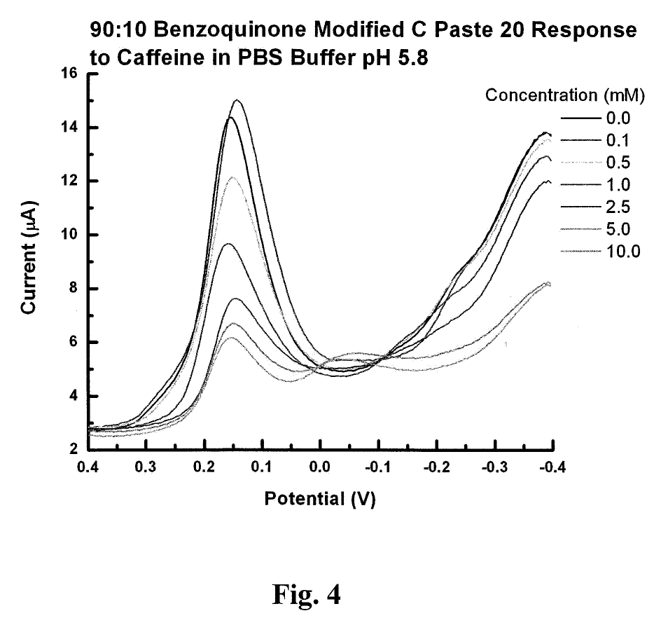

Results obtained using the apparatus and method of the present invention for different concentrations of caffeine were then determined. FIG. 3 shows a plot of peak current as a function of caffeine concentration. The decrease in peak current is quite obvious in this plot. FIG. 4 shows voltammograms for different caffeine concentrations. As can be seen, the peak current decreases with increasing concentration.

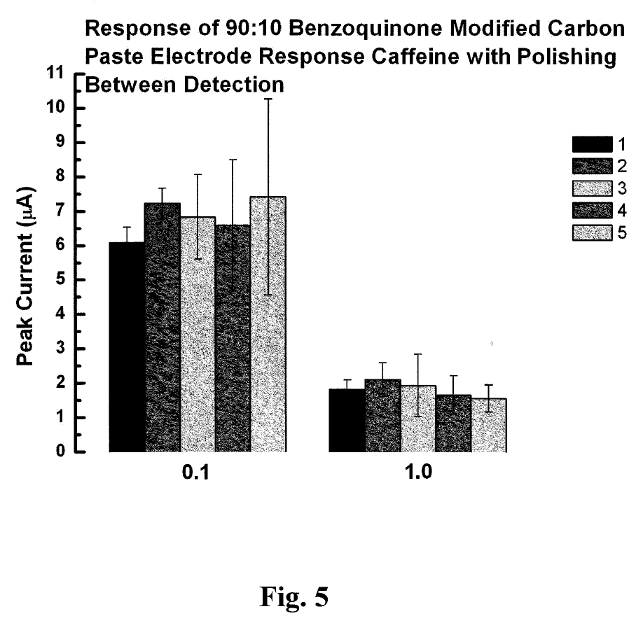

To test the viability of the sensor in coffee, FDA mandated levels in mg of caffeine per mL of beverage were tested. Following accepted guidelines, 0.1 mM (equivalent of the levels in decaffeinated coffee) and 1.0 mM (equivalent of caffeinated beverages) caffeine samples were tested to determine if the two levels could be distinguished in a simple yes/no format. To test this system, electrodes were constructed as hereinabove described. Between runs, the electrodes were polished with paper to make sure the surface was fresh. FIG. 5 shows a series of peak currents averaged across three runs for each of five different electrodes in the low and high caffeine concentrations. This data clearly shows the ability to differentiate the two caffeine levels.

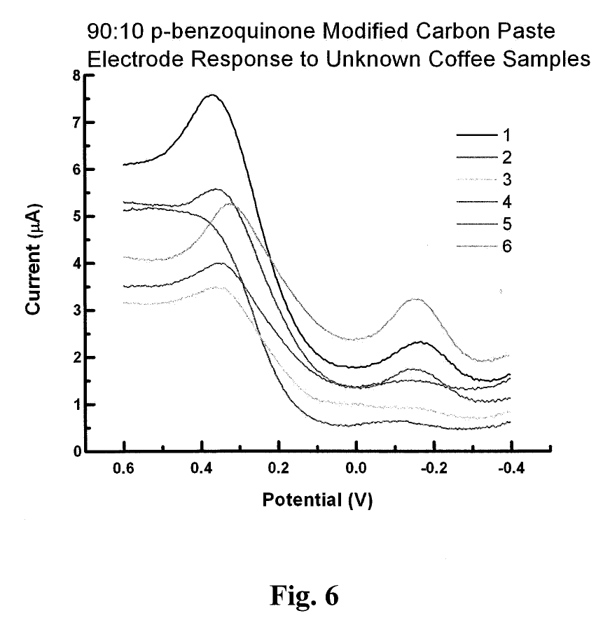

Next, real beverages (unknowns) were tested using the sensor system. The same protocol used in the high/low concentration testing show in FIG. 5 was followed. FIG. 6 shows voltammograms obtained for 6 samples. There are some very notable differences between the real samples shown here and the standards shown above. In the standard solutions, one well defined peak at ˜0.17 V was observed. In these studies, a well-defined peak at −0.17 V was seen as well as a peak at +0.35 V. It is obvious from this result that redox active compounds such as other stimulatory methylxanthines besides caffeine are present in the samples. Peak currents at both potentials were analyzed. To determine which were caffeinated and which were decaffeinated, the three runs with the larger peak currents for both the positive and negative voltage were determined to be the decaffeinated samples, unknown # 1, 3, and 4. The caffeinated samples were determined to be the ones that gave the smallest peak currents for the positive and negative voltages, unknown # 2, 5, and 6. This resulted in a 100% match of these blind samples.

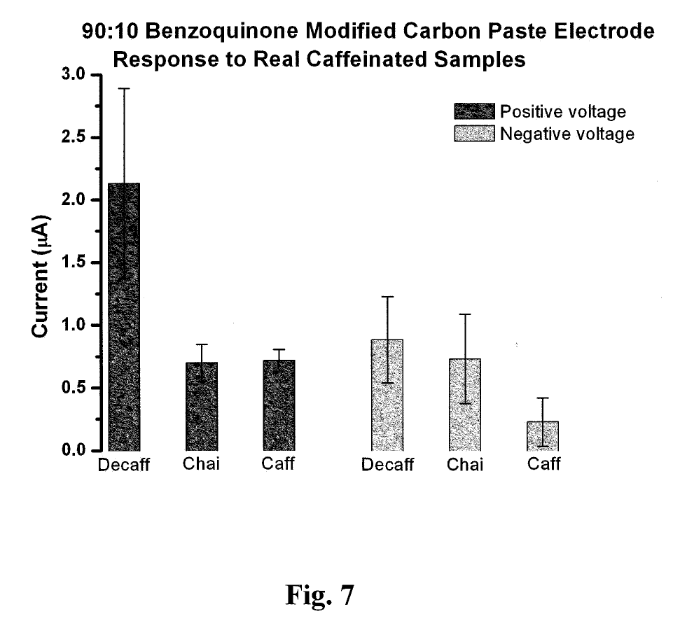

As a final test of the system, three known samples were compared at both high and low detection voltages. FIG. 7 shows a comparison of the peak currents for the samples. Three electrodes were run one time each in decaffeinated coffee, caffeinated coffee and mystic spiced chai. As observed previously, the peak current response for the decaffeinated and caffeinated coffee samples differed significantly at the positive voltage (0.25 to 0.32 V). The peak current for the positive voltage show a significant difference between caffeinated and decaffeinated coffee. There was approximately a magnitude of difference between the coffee samples. Chai tea samples, although claimed to be 99.8% caffeine free by the manufacturer, showed similar peak currents to that of the caffeinated coffee at the positive voltage. This may be due to the presence of non-caffeine methylxantines. The peak current response of the electrodes to the caffeinated and decaffeinated samples at the negative voltage are also different. The chai tea samples at the negative voltage are closer to that of the decaffeinated sample and thus it may be possible with this sensor to differentiate between caffeine levels and total levels of methylxanthine stimulants in a beverage.

In view of the foregoing, the new and novel testing procedure using the system and method of the present invention may be employed to test a liquid or beverage for the presence and concentration or level of a stimulant, by way of example, caffeine, as follows: First, a small sample of the beverage is placed on the test strip 113, or, alternatively, the test strip may be dipped into the sample liquid. The test strip would is inserted into the slot 110 formed in the end 104 of the detector body 102. The flow of electrons between the electrode and the electrical conductor would be measured and calibrated to provide a specific stimulant concentration value or range, depending upon the electrical characteristics of the electrode. A read out of the stimulant concentration is displayed on indicator 114.

Changes may be made to the above methods, systems and structures without departing from the scope of the present invention. It should be noted that the subject matter contained in the above description and/or shown in the accompanying drawings should be interpreted as illustrative and not in a limiting sense. The following claim(s) are intended to cover all generic and specific features described herein as well as statements of the scope of the present invention, which, as a matter of language, might be said to fall there between.

What is claimed is:

1. A sensor for detecting and measuring the level of stimulants in a liquid, the sensor comprising:
a source of electrical power;
a test strip including at least one electrode having an electrical conductor in electrical communication therewith;
an elongated body portion having
a first end, a second end, a longitudinal axis extending the length of the body portion intermediate the first and second ends, and an aperture formed in the first end and extending along the longitudinal axis and adapted to releasably receive the test strip; and
an indicator for providing a visual indication of the level of the stimulants in the liquid.

2. The sensor of claim 1 wherein the at least one electrode is a carbon electrode.

3. The sensor of claim 1 wherein the at least one electrode is supported by an inert substrate.

4. The sensor of claim 2 wherein the at least one electrode comprises a mixture of graphite powder and mineral oil.

5. The sensor of claim 4 wherein the at least one electrode further includes a stimulant sensitizing agent.

6. The sensor of claim 5 wherein the stimulant sensitizing agent is p-benzoquinone.

7. The sensor of claim 5 wherein the concentration of the stimulant sensitizing agent is in the range of approximately 5 to approximately 15 percent by weight.

8. The sensor of claim 2 wherein the at least one electrode further includes a stimulant sensitizing agent.

9. The sensor of claim 8 wherein the stimulant sensitizing agent is p-benzoquinone.

10. The senor of claim 1 wherein the electrical conductor is a copper wire.

11. The sensor of claim 4 wherein the mixture is homogenized.

12. The sensor of claim 3 wherein the inert substance comprises glass.

13. The sensor of claim 3 wherein the inert substance comprises a plastic material.

14. The sensor of claim 5 wherein the at least one electrode is deposited on the substrate by a contact printing process.

15. The sensor of claim 5 wherein the at least one electrode is deposited on the substrate by a non-contact printing process.

16. A method for detecting and measuring the level of stimulants in a liquid comprising:
exposing the liquid to a test strip, the test strip including a power source and at least one electrode coupled to an electrical conductor;
measuring the flow of electrons between the at least one electrode and the electrical conductor; and
calibrating the measured electron flow to the type and concentration level of the stimulant in the liquid.

17. The method of claim 16 wherein the at least one electrode comprises a mixture of graphite powder and mineral oil.

18. The method of claim 17 further including sensitizing the mixture by adding a stimulant sensitizing agent.

19. The method of claim 18 wherein the stimulant sensitizing agent is p-benzoquinone.

20. The method of claim 18 wherein the concentration of the stimulant sensitizing agent is in the range of approximately 5 to approximately 15 percent by weight.

21. The method of claim 19 wherein the concentration of p-benzoquinone is in the range of approximately 5 to approximately 15 percent by weight.

22. The method of claim 18 further including the step of homogenizing the mixture.

23. The method of claim 18 wherein the at least one electrode is secured to an inert substrate material.

24. The method of claim 23 wherein the at least one electrode is secured to the inert substrate material by screen-printing.

25. The method of claim 23 wherein the at least one electrode is secured to the substrate material by ink-jet printing.

26. The method of claim 23 wherein the inert substrate material is glass.

27. The method of claim 23 wherein the inert substrate material is a plastic material.
